(19) United States
(12) Patent Application Publication
(10) Pub. No.: US 2002/0084991 A1
(43) Pub. Date: Jul. 4, 2002

(54) Simulating mouse events with touch screen displays

(76) Inventors: Edward R. Harrison, Beaverton, OR (US); Jason Dishlip, Hillsboro, OR (US)

Correspondence Address: Timothy N. Trop, TROP, PRUNER & HU, P.C., STE 100, 8554 KATY FWY, HOUSTON, TX, 77024-1805, US

(21) Appl. No.: 09/754,555

(22) Filed: Jan. 4, 2001

(51) Int. Cl. G09G 5/00

(52) U.S. Cl. 345/173

(57) ABSTRACT

Touch screen interactions may be converted into conventional mouse commands. Various interactions associated with a cursor image may be converted into conventional mouse cursor commands. These mouse cursor commands may then be recognized by software which expects mouse cursor commands despite the fact that the touch screen system may include no mouse.

### BACKGROUND

This invention relates generally to using touch screen displays for processor-based systems.

Conventionally, touch screen displays may be utilized to provide user inputs to processor-based systems. The user can touch the display screen with a finger or a stylus to indicate a selection.

Positioning a mouse cursor over a selectable display element may generate an event. For example, causing the mouse cursor to “hover” over a selectable display element may generate an event. The element may be highlighted or an insert box may be displayed that provides information about the element. Similarly, moving the mouse generates mouse cursor move events that cause the on-screen cursor to be moved in correspondence with the user's mouse movement. Similarly, when a button on the mouse is selected, a mouse click event may be generated, for example, to select a display element under the mouse cursor.

Generally, these mouse commands are well known to software designers of processor-based systems. Unfortunately, they are generally not available with touch screen displays. For example, it is generally not possible to detect when a finger is hovering over a touch screen because the touch screen only works when it is touched.

A large amount of conventional software, including browser software, operating system software and application software, as a few examples, may operate based on conventional well-known mouse commands that are conventionally recognized and conventionally utilized to provide user inputs to application programs. Unfortunately, this software is not amenable to operation with processor-based systems that utilize touch screens. This is because the touch screens do not provide commands that are recognized as conventional mouse cursor commands.

As a result, conventional software, in some cases, may not be usable with processor-based systems that use a touch screen as an input-output device. In particular, touch screen generated input commands may be incompatible with software that expects commands in the format conventionally associated with mouse cursor command protocols.

Thus, there is a need for a way to provide mouse functionality in connection with touch screens.

### BRIEF DESCRIPTION OF THE DRAWINGS

FIG. 1 is a schematic depiction of one embodiment of the present invention;

FIG. 2 is a flow chart for software in accordance with one embodiment of the present invention; and

FIG. 3 is a block diagram of one embodiment of a hardware device in accordance with the present invention.

### DETAILED DESCRIPTION

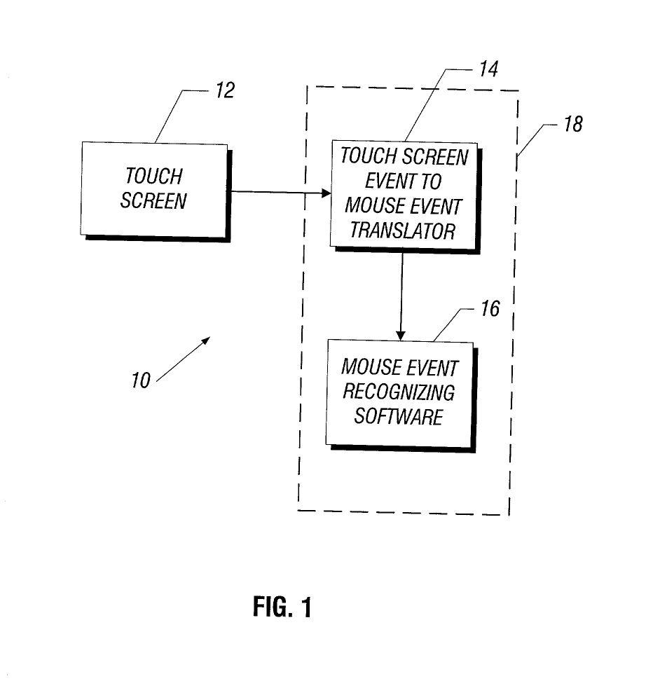

Referring to FIG. 1, a touch screen display 12 may be coupled to a processor-based system 18. The processor-based system 18 may include software 14 that translates touch screen events into mouse events. Thus, processor-based system 18 software 16, which expects to receive mouse events, receives events generated from the touch screen 12 that are recognized by the software 16 as though the touch screen events were mouse events. This may occur despite the fact that the system 18 does not use a mouse and no mouse operation is utilized in connection with the touch screen 12.

Instead, interaction with the touch screen 12 in an appropriate fashion is translated into a mouse event by the software 14 and forwarded to the software 16 to implement the appropriate software controls. In other words, the software 16 responds to interaction with the touch screen 12 as though a mouse had been utilized. Thus, conventional software that relies on mouse events may be utilized in connection with touch screens.

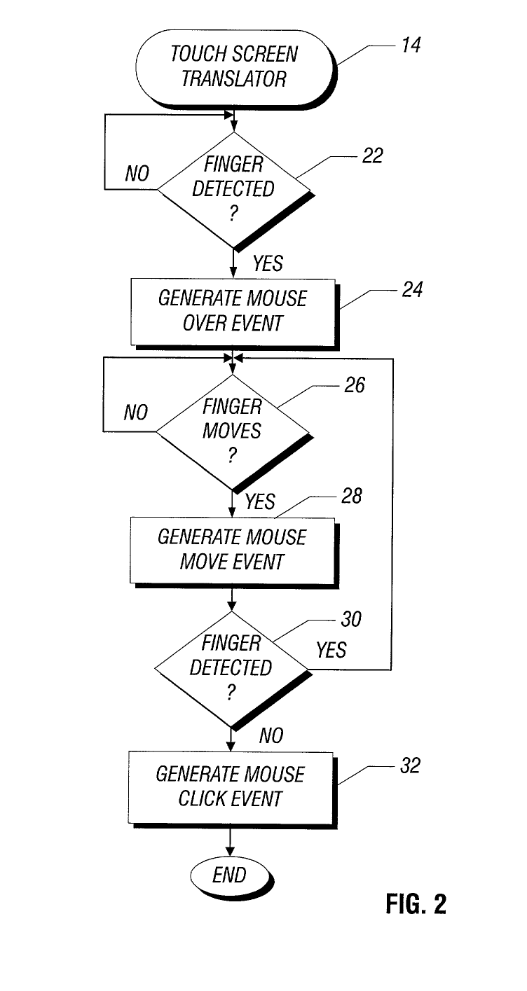

In accordance with one embodiment of the present invention, shown in FIG. 2, touch screen translator software 14 may detect the presence of the user's finger or stylus on the touch screen 12, as indicated in diamond 22. In response to the detection of the finger/stylus, a mouse over event may be generated, as indicated in block 24. A mouse over event corresponds to a mouse cursor being positioned over a display element, without selecting that element by a mouse click.

A check at diamond 26 determines whether the user's finger/stylus moves. If so, a mouse move event may be generated as indicated in block 28. A mouse move event corresponds to movement of a mouse which results in movement of the position of the mouse cursor on a display screen in correspondence to the user's mouse movement.

A check at diamond 30 determines whether the finger/stylus presence is still detected on the touch screen 12. If so, the flow iterates to monitor for finger/stylus movement at diamond 26. Otherwise, a mouse click event may be generated as indicated at block 32. When the user removes the user's finger/stylus from the touch screen 12, the display element last under the user's finger/stylus may be determined to have been selected. As a result, a mouse click event, corresponding to the actuation of a mouse button, may be generated.

Thus, the software 14 may implement mouse commands including the mouse over, mouse move and mouse click events. Other conventional mouse events may be generated as well. Different finger/stylus actuations can be recognized as the mouse over, move or click event. However, in each case, a particular finger/stylus movement or actuation may be translated into a corresponding mouse event that may be recognized by software 16 that expects conventional mouse commands.

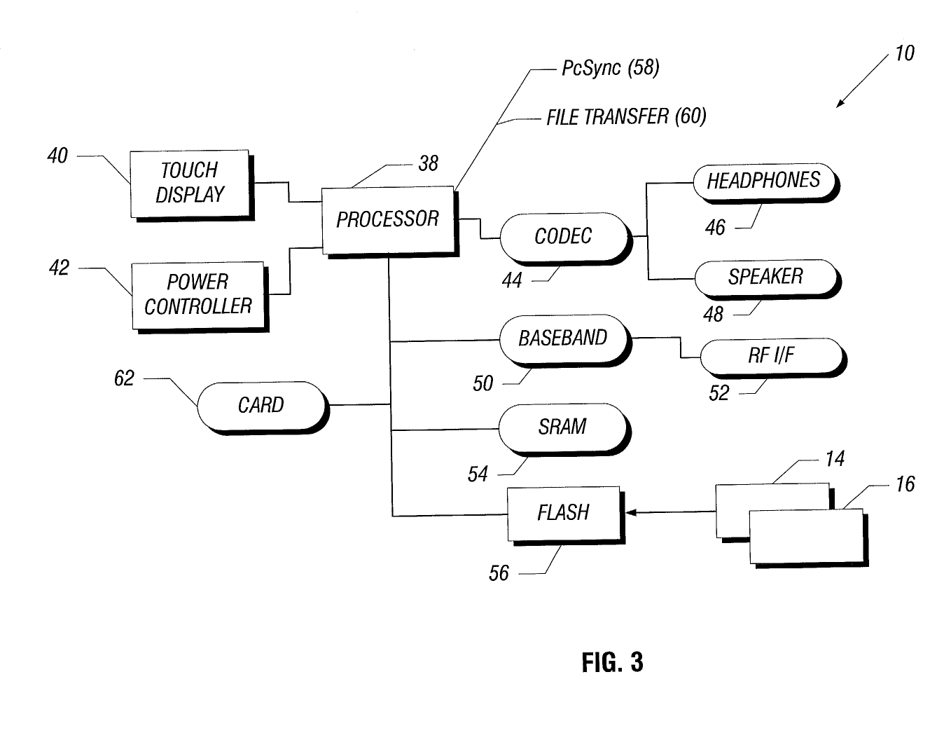

Finally, referring to FIG. 3, one embodiment of a processor-based system 10 to implement the present invention is illustrated. Of course, the present invention is not in any way limited to any particular hardware architecture or arrangement. The embodiment shown in FIG. 3 is simply an illustration of a wireless mobile processor-based device.

In the system 10, a processor 38 is coupled to a touch screen display 40 and a power controller 42. The processor 38, in one embodiment, may be the StrongARM brand processor available from Intel Corporation. The processor 38 may also communicate with a host processor-based system using sync signals 58 and file transfer signals 60.

The processor 38 is also coupled to a coder/decoder or codec 44. The codec 44 provides an analog output signal to headphones 46 or speakers 48.

A baseband section 50 is coupled to a radio frequency interface 52 in one embodiment. The interface 52 may facilitate communications with a base station using a wireless protocol. This may be the case in a variety of portable devices including web tablets and personal digital assistants, as two examples. In other embodiments, the system 10 may be a standalone system, may communicate over a tethered cable with a base station, or may use other wireless techniques such as infrared technology.

The processor of 38 is also coupled to a static random access memory (SRAM) 54 and a flash memory 56 in one embodiment. In that embodiment, the translator software 14 and the software 16 may be stored in the flash memory 56. Of course, other types of storage devices, such as hard disk drives, may also be used in other applications. The processor 38 is also coupled to one or more peripheral cards 62.

The touch screen translator software 14 may be integrated into conventional application programs on a given processor-based system. For example, the software 14 may be integrated into Internet browser software. In addition, the software 14 may be integrated into a graphics support layer that is used for building graphical user interfaces, such as a Java Abstract Window Tool Kit (AWT). In some cases, the software 14 may even be incorporated into the operating system. It may even be useful in many cases to integrate the translator software 14 into the graphics support layer to allow a large number of application programs to run with touch screen displays without alteration of the operating system itself.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving touch information from a touch screen; and
converting said touch information into mouse commands.

2. The method of claim 1 wherein converting said touch information into mouse commands includes converting said touch information into mouse cursor control commands.

3. The method of claim 1 including detecting contact with said touch screen and generating a mouse event in response to said contact.

4. The method of claim 1 including sensing movement on said touch screen and generating a mouse event in response to the detection of movement.

5. The method of claim 1 including detecting the cessation of contact with the touch screen and generating a mouse click event in response to the detection of the cessation of contact.

6. The method of claim 1 including providing said touch information to software that only recognizes mouse events.

7. An article comprising a medium storing instructions that enable a processor-based system to:
receive touch information from a touch screen; and
convert said touch information into mouse commands.

8. The article of claim 7 further storing instructions that enable the processor-based system to convert the touch information into mouse cursor control commands.

9. The article of claim 7 further storing instructions that enable the processor-based system to detect contact with the touch screen and generate a mouse event in response to the contact.

10. The article of claim 7 further storing instructions that enable the processor-based system to sense movement on the touch screen and generate a mouse event in response to a detection of movement.

11. The article of claim 7 further storing instructions that enable the processor-based system to detect the cessation of contact with the touch screen and generate a mouse click event in response to the detection of the cessation of contact.

12. The article of claim 7 further storing instructions that enable the processor-based system to provide the touch information to software that only recognizes mouse events.

13. A system comprising:
a processor; and
a storage coupled to the processor, the storage storing instructions that enable the processor to receive touch information from a touch screen and convert the touch information into mouse commands.

14. The system of claim 13 including a touch screen coupled to the processor.

15. The system of claim 13 wherein said storage stores instructions to convert the touch information into mouse cursor control commands.
